(19) United States
(12) Patent Application Publication
(10) Pub. No.: US 2007/0092608 A1
(43) Pub. Date: Apr. 26, 2007

(54) DISPOSABLE PACKAGING FOR A READY-MADE FOOD PRODUCT

(76) Inventors: Antonio Palamara, Catona, Reggio Calabria (IT); Mariantonia Cotronei, Catona, Reggio Calabria (IT)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/613,080

(22) Filed: Dec. 19, 2006

Related U.S. Application Data
(62) Division of application No. 10/482,853, filed on Jan. 5, 2004, now Pat. No. 7,163,102.

(30) Foreign Application Priority Data
Jul. 13, 2001 (IT) RM2001U000132
Mar. 27, 2002 (IT) RM2002U000056

(51) Int. Cl. A23B 7/148

(52) U.S. Cl. 426/106

(57) ABSTRACT

Disposable packaging, comprising a container that defines a main compartment and at least an additional compartment. The container is bowl-shaped and is closed on the upper side by a film, or by a cover, in order to prevent the main food component contained inside the main compartment from coming out. Moreover, the additional compartment is closed by a slidable sealing system of the cylinder-piston type. In the closure position of the piston, which is formed by a plug, the food component contained in the additional compartment cannot mix with the food component located in the main compartment, whereas in the opening position of the plug, the dressing/seasoning may leak from the additional compartment through lateral apertures of the plug, at the time the user turns over and shakes the packaging.

### CROSS-REFERENCE TO RELATED APPLICATIONS

This application is a divisional application under 35 U.S.C. §121 and 37 CFR 1.53(b) based upon co-pending U.S. application Ser. No. 10/482,853 filed Jan. 5, 2004. Additionally, this divisional application claims the benefit of priority of co-pending U.S. application Ser. No. 10/482,853 filed Jan. 5, 2004 and International Application No. PCT/IT02/00454 filed Jun. 10, 2002. The entire disclosures of the prior applications are incorporated herein by reference.

### BACKGROUND OF THE INVENTION

1. Field of the Invention

The present invention relates to the field of food products' packaging, and specifically to a packaging designed to contain food products that are ready to be eaten or ready for preparation and that consist of two or more components to be mixed together before use.

For instance, the invention may be used to mix vegetables with their dressings, pasta with sauces or gravies, bread-crumbs with beaten eggs (for the preparation of omelet's), meat or fish with their coverings of bread-crumbs (for the preparation of fried dishes), and so on.

Therefore, the invention is not only useful for the final user, that is, for the person who will actually eat the food product, but could be employed in the kitchen of a restaurant, or in the domestic environment, in order to facilitate or speed up the preparation of food products that precedes their successive treatment (e.g. frying, cooking inside a microwave oven, etc.).

2. Description of the Prior Art

At present, there are known various kinds of packaging for ready-made food products, that are used both in the domestic and non-domestic environment. These kinds of packaging include a plastic-made container (receptacle) which is open upwardly, like a bowl, and which is completely wrapped by a sealing film of cellophane or the like.

The container has at least one compartment for a first food component to be seasoned, and at least a second compartment for small bags (sachets) containing a sauce or the like.

The user that has removed the external seating film (or possibly an upper cover of the container) opens one or more sachets available to him, after taking them from the respective compartment, and then pours their content in the compartment that contains the food product to be seasoned.

A drawback of such a packaging for food is that it is very easy to inadvertently pour the content of the small bags on one's clothes or on other objects, and therefore this operation is not very convenient and hygienic to carry out. Moreover, since the food to be seasoned usually occupies (due to space optimization) the whole volume of its respective compartment (forming the greatest part of the volume of the packaging), the operation of seasoning the food product (e.g. salad) is very difficult, if not impossible to carry out, if one wants to avoid to pour (spread) the food product out of the already opened packaging.

Therefore, an object of the present invention is to provide a packaging for food that allows to mix the various components of the food in a hygienic and efficient way.

The use of compartmented storage containers is known in the prior art. For example, European Patent Number EP 0,790,190; Great Britain Patent Number GB 2,211,479 A; and U.S. Pat. No. 4,793,476.

### SUMMARY OF THE INVENTION

The above objects are attained according to the claims, by means of a ready-made dish disposable packaging with several compartments:

an upwardly open container (1), an upper closure element (A) of the container (1), a compartment (2) of the container (1) for a first component of the food product, and at least an additional compartment (3) that is realized integrally with the container (1) or is rigidly fixed thereto in a non-removable manner, and which is used for an additional component of the food product to be mixed to said first component, said additional compartment (3), which is initially sealed, having movable members (13, 14) that may be actuated by the user from outside the container (1) and which realize a communication path between the compartment (2) and said additional compartment (3), thereby allowing to mix the first component of food product, located inside the compartment (2), to the additional component of food product coming from the additional compartment (3), said movable members being formed by a base (13) of said additional compartment (3), that is connected by means of a hinge (15) to the walls (9) of the compartment (3), and said base (13) being movable between a first- or rest-position, and a second position, whereby during the displacement to the second position the base acts on a movable plug (14) which slides along the walls of said additional compartment (3); said plug (14) having lateral apertures which give rise to said communication between the compartment (2) and the additional compartment (3), in said second position of the movable base (13), when said plug (14) has reached a second, final position, without releasing itself from said walls (9) of the compartment (3).

The above objects are also attained by a combination between a disposable packaging for a first component of a food product, and a separate and sealed container (24) for a second component of the food product, in which:

the packaging comprises a container (1) with an upper closure element and a lower closure element, a compartment (2) for the first component of the food product in which said components are to be mixed together, and a coupling hole (11″) for the connection to said sealed separate container (24);

the initially sealed container (24) has movable piston-like members (13′, 14) that are actuated by the user and realize a communication path between said compartment (2), and an additional compartment (3) defined by the separate sealed container (24) itself, after the removal of the lower closure element, after the mechanical coupling of the separate sealed container (24) to the coupling hole (11″), and lastly, after the actuation of said movable members (13′, 14), said movable members are formed by a base (13′) of said additional compartment (3), connected by a hinge (15′) to the walls (9′) of the compartment (3), and wherein said base (13′) is movable between a first- or rest-position, and a second position, and during the displacement to the second position the base acts on a movable plug (14) that slides along the walls of said additional compartment (3); the said plug (14) having lateral apertures which give rise to said communication path between the compartment (2) and the additional compartment (3), in said second position of the movable base (13′).

As disclosed in more detail, the movable members could also be designed to break the sealing means of the additional compartment, and form—for instance—a push rod or pointed rod having an oblique upper end, designed to break a sealing plastic/aluminum film of the additional compartment.

The pointed rod or push rod is preferably integrally formed with the container during the plastic moulding process.

The push rod has longitudinal channels in order to facilitate the leaking of the sauce, dressing, or the like, from the additional compartment.

The advantages of the present invention will result from the detailed description of its preferred embodiments.

### BRIEF DESCRIPTION OF THE DRAWINGS

The present invention and its specific advantages will be described for purely illustrative and non-limitative purposes, with reference to the accompanying drawings, in which:

FIG. 1 is an axonometric view of the invention, corresponding to an embodiment of the present invention, without the upper sealing film or cover, and with the plug in the opening position;

FIG. 2 is a view similar to FIG. 1, the plug being in the closure position;

FIG. 3 is a vertical sectional view of the invention shown in FIG. 1 and FIG. 2, without the plug;

FIGS. 4a and 4b are vertical sectional views of the invention, corresponding to an embodiment of the present invention;

FIG. 5 is a view of a detail of the central portion of the container of FIG. 3, with the plug in the closing position;

FIG. 6 is a view similar to FIG. 5, the plug being in the opening position;

FIG. 7 is an axonometric view of the lower side of the packaging of FIG. 1;

FIG. 8 is a sectional axonometric view of the packaging, corresponding to an embodiment of the present invention;

FIG. 9 is a schematic view of a vertical section of the packaging shown in FIG. 8;

FIG. 10 is a schematic view in vertical section, analogous to FIG. 9, in which, however, the additional compartment is located centrally in the packaging instead of laterally;

FIG. 11 is a vertical sectional view enlarged with respect to FIGS. 9 and 10 of the additional compartment containing the dressing or the like;

FIG. 12 is a view analogous to FIG. 11, showing the use of the push rod for breaking and tearing the sealing film, corresponding to an embodiment of the present invention.

### DESCRIPTION OF THE PREFERRED EMBODIMENT

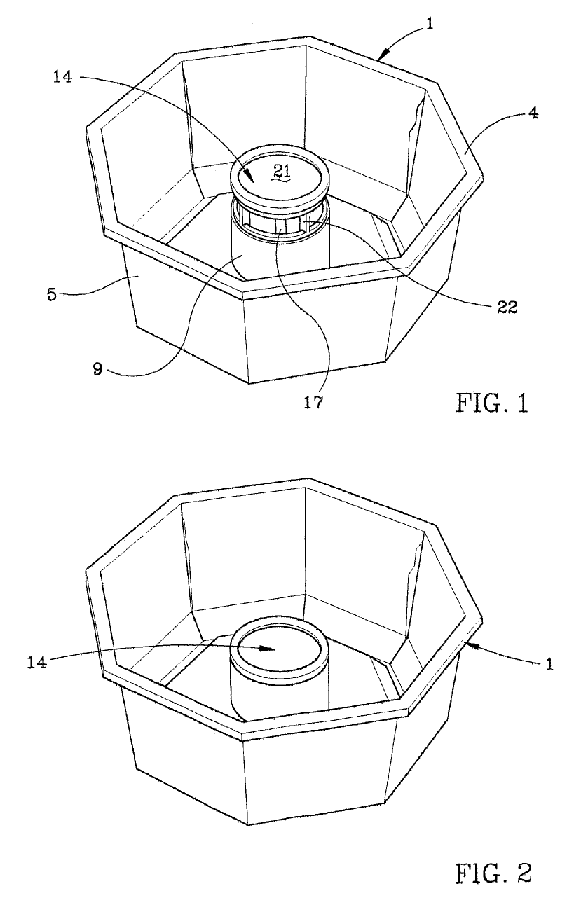

Referring now to the drawings, and particularly to FIGS. 1-12, a preferred embodiment of the disposable packaging for a read-made food product of the present invention is shown in FIGS. 1-7.

In all Figures the same reference number is used for an identical component of the packaging, so that the invention may be more readily understood.

The packaging essentially comprises a container 1 which for instance is obtained from a moulding process of plastics.

The configuration of the container 1 is such as to give rise to two separate compartments, denoted by 2 and 3 respectively. The compartment 3 is centrally located and has a cylindrical shape, while the greater compartment 2, that surrounds the compartment 3, has a substantially prismatic and polygonal shape with several congruent faces. Obviously, these shapes of the compartments are not limitative, and the same holds for the position of the compartment 3, although for a more uniform distribution of the food product component contained in the compartment 3 towards the inside of the compartment 2, containing the other component of the food product, the preferred position is the illustrated one.

The container 1 is formed by:

an upper flange 4, on which a sealing film is applied (not shown), e.g. by heat sealing, ultrasonic welding, adhesives, or any other possible sealing method suited to close the open upper part of the container 1;

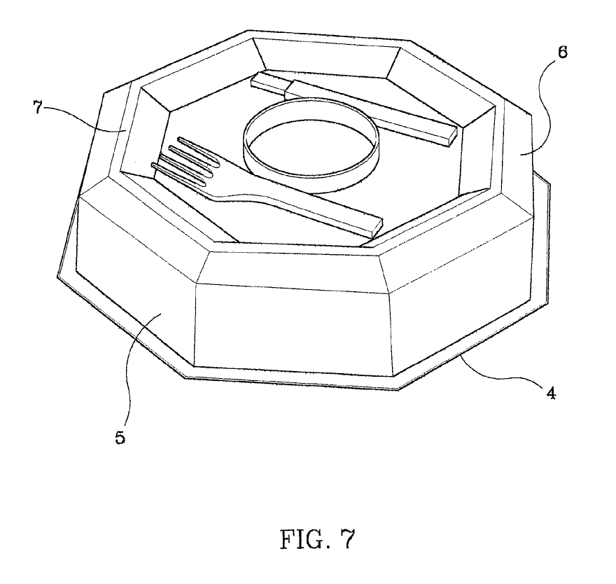

a side wall 5 with facets (or faces) having a polygonal horizontal section, the side wall terminating at its lower end in an annular projection 6, also visible in FIG. 7;

an annular lower planar surface 7, formed on said projection 6, to which a second sealing film is applied (not shown) by any known sealing method;

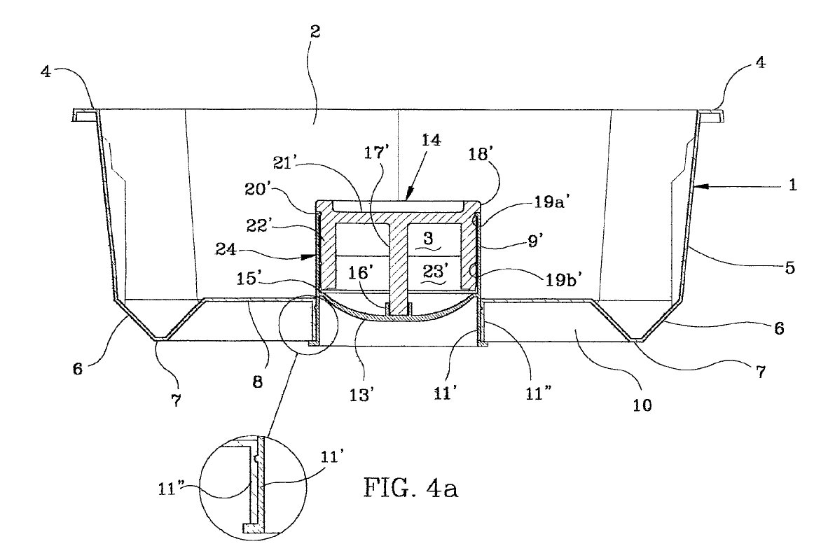

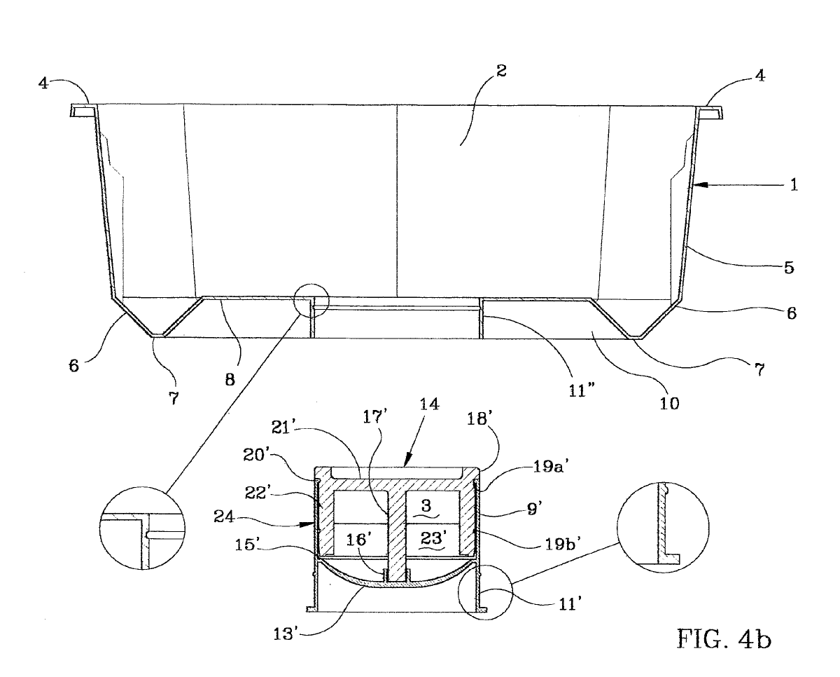

a base wall 8, extending from the internal upper end of the annular projection 6, to a cylindrical wall 11 (11″ in FIG. 4a);

a movable base 13 (13′ in FIG. 4a) used to actuate a plug 14, this movable base being connected by means of a hinge 15 (15′ in FIG. 4a) (of reduced thickness), to the cylindrical wall 11 (or 11′) of the compartment 3, in order to reach a convex form when the plug 14 is made to slide inside the “boring” formed by the cylindrical wall 9 (or 9′).

Moreover, some pieces of cutlery (e.g. of plastics) or other fittings (e.g. napkins), or additives of the food product, may be received in the annular recess 10 and are retained from below by said film (not shown) which is applied on the planar annular surface of the annular projection 6 (FIG. 7).

In an embodiment the container 1 is integrally formed (e.g. of moulded plastics). However, the plug 14 forms a separate piece (e.g. of plastics).

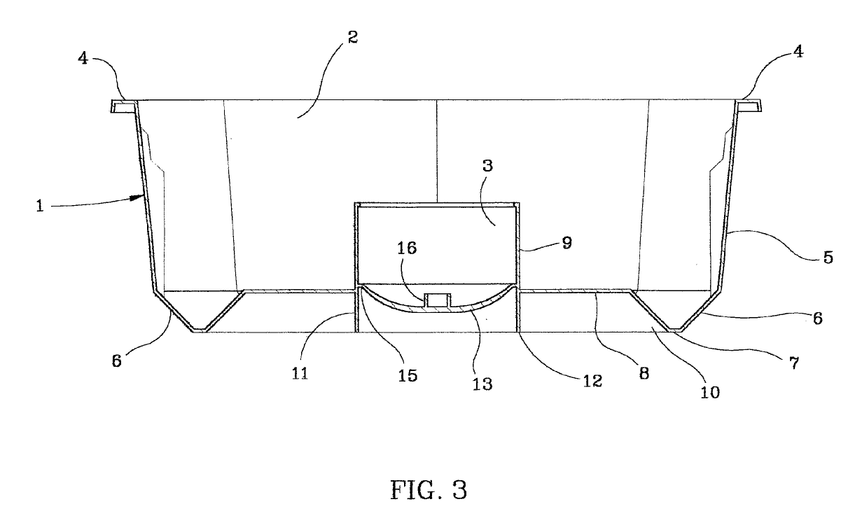

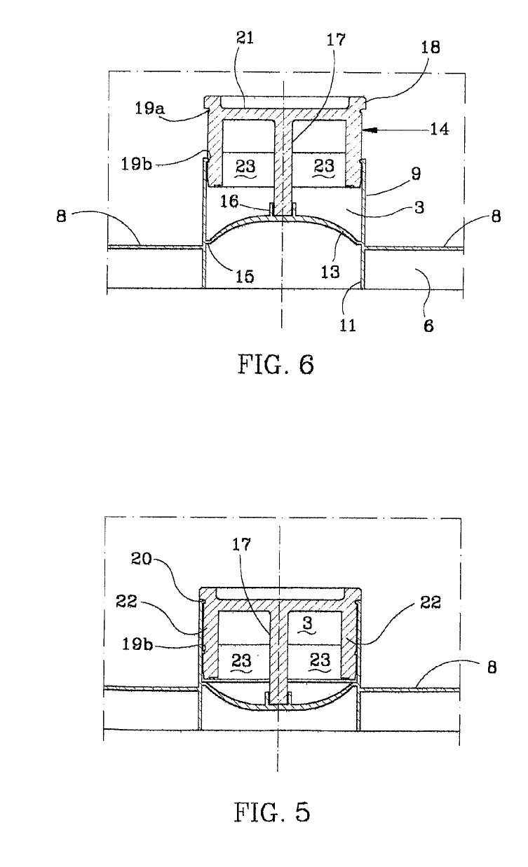

It must be stressed that the plug 14 has been omitted for clarity in FIG. 3, to simplify the drawing, since it is shown in any case in the detailed views of FIGS. 5 and 6. Actually, when the packaging is purchased by the user, it includes the plug 14 (in the closure position illustrated in FIGS. 2 and 5), the film applied on the upper side, that is on the upper annular flange 4 (or possibly a removable cover which is also omitted in the drawings), and the film applied on the lower side, that is on the annular planar surface 7 of the projection 6.

To better understand the structure and operation (use modalities) of the packaging according to the present invention, reference will now be made in particular to the FIGS. 5 and 6.

The latter Figures are representations in vertical section, limited to the central portion of the container 1, and in particular they show the cylindrical wall 9 of the compartment 3 which contains the sauce or dressing, the lower extension 11 of this cylindrical wall, the circular hinge 15, and part of the base wall 8. Moreover, the plug 14 is inserted (in the initial rest position of FIG. 5), inside the compartment 3, and is in sliding engagement with the inner side of the vertical cylindrical wall 9 of this compartment 3.

The movable base 13 for the actuation of the plug 14 includes centrally a cylindrical rib, or annular cylindrical portion 16, that is integrally formed on the movable base 13. Said circular rib 16 receives (e.g. by press-fitting) the lower portion of an axial stem 17 of the plug 14. Moreover, the plug 14 has two circular peripheral grooves 19a and 19b, which are parallel to each other, and the upper end of the cylindrical wall 9 has a (inwardly directed) circular bead or ridge 20 complementary to the shape of the grooves 19a and 19b, adapted to engage with the upper groove 19a in the closing position of the plug 14 (FIG. 5), and with the lower groove 19b in the opening position of the plug 14 (FIG. 6).

The exact configuration of the plug 14 may be inferred besides from FIGS. 5 and 6 also form FIG. 1. The plug 14 includes a portion shaped like a flanged disc 21, whose circular flange 18 abuts on the upper end of the cylindrical vertical wall 9, in the closure position of the plug 14 (FIG. 5); the plug 14 also includes vertical elements 22, shaped as small rods and extending downwards in a direction perpendicular to the plane of the flanged disc 21, said vertical elements being integral with the latter. The vertical small rods 22 terminate at their lower end in a cylindrical ring 23. The plug 14 is able to slide, by means of the external surfaces of its portions 22 and 23, along the inner side of the cylindrical vertical wall 9. Moreover, it may be noted that the various vertical small rods 22 of the plug 14, are arranged at equal angles along the periphery of the flanged disc 21 that forms the upper part of the plug 14. Thus, the small rods 22 delimit “windows” of equal dimensions, that are clearly visible in FIG. 1, and which allow the leaking of the sauce or dressing from the compartment 3, when the plug 14 is in the opening position (FIGS. 1 and 6). In FIG. 1 the small rods 22 are at 90° with respect to each other.

First of all, the user of the packaging shown in FIGS. 1 to 3, and 5 to 7, removes the lower film, and then, he/she pushes inwardly the movable base 13 towards the inside of the packaging. The movable base lifts the plug 14 by means of the axial stem 17, and at the same time it lifts the sauce or dressing contained in the compartment 3 immediately above the movable base 13. During this operation, the circular ridge 20 that realized a seal in the rest position of the plug 14 (see FIG. 5) thereby preventing the leaking of the sauce or dressing to the compartment 2 disengages from the upper circular groove 19a. In the upper position, or end-of-stroke position, of the plug 14, the circular ridge 20 engages the second (lower) circular groove 19b of the plug 14, thereby realizing again a sealing, so that the sauce etc. can flow only through the windows defined between the vertical small rods 22. In the position shown in FIG. 6, of the plug 14, the movable base 13 will have an upwardly convex configuration.

In the preceding description it is assumed that the words “upper” and “lower”, and “upwards” or “downwards”, refer to the orientation of the packaging (and therefore of the container 1), that is shown for example in FIGS. 1 and 2.

Without removing the cover (or the upper film), the user turns over the packaging in order to allow the complete downflow of the sauce, or dressing, or bread-crumbs, etc. through the “windows” or apertures formed between the small rods 22. Then, the user shakes the packaging in order to perfectly and uniformly dress a salad, for instance.

At that time, if the food product (e.g. a salad) can be immediately eaten, the user simply removes the upper sealing film or an upper cover, and can directly use the compartment 2 as a bowl.

On the other hand, in case of a food product that must be fried, the user (in this case a cook) must tear the upper film and pour the content in a frying-pan or the like. However, in case of a microwave oven, it will be possible to directly employ the container 1 as a cooking container.

Therefore, it can be seen that the objects of the invention are fully attained. Particularly, it will be impossible to pour the seasoning out of the container 1, since the upper film will not be removed, except when the seasoning operation is completed. Moreover, the sachets (small bags) of the prior art are totally superfluous, and the space inside the compartment 2 may be better used.

Now, we will describe an alternate embodiment of the packaging present invention, referring to FIGS. 1, 2, 4a, 4b and 7.

In the embodiment, shown in FIGS. 4a and 4b, the compartment 3 is formed by a separate container 24 (or “cartridge”), that can be inserted, that is, press-fitted, in a central hole of the container 1, having an inner diameter substantially equal to the external diameter of the separate container 24. The separate container, indicated by a denser hatching, has a cylindrical wall 9′ with a downward extension 11′, and may be inserted inside a sleeve 11″ of the container 1. From the details of FIGS. 4a and 4b, it can be seen that the downward projection 11′ is flanged at its lower end, and moreover it has an annular projection (ridge) acting as a retainer, in order to mutually lock the respective parts. Obviously, the flange acts as a stop, in order to stop the stroke of the separate container 24 towards the inside of the container 1. The plug 14 is located (in the initial rest position shown in FIGS. 4a and 4b) inside the cartridge 24, and is in sliding contact with the cylindrical vertical wall 9′ of the compartment 3.

The movable base 13′ for the actuation of the plug 14 has centrally a cylindrical rib, or cylindrical annular portion 16′, which is integrally formed on the movable base 13′ of the cartridge. Said circular rib 16′ receives (e.g. by press-fitting) the lower portion of an axial stem 17′ of the plug 14. Moreover, the plug has two peripheral circular grooves 19a′ and 19b′, that are parallel to each other, while the upper end of the cylindrical wall 9′ has a (inwardly directed) ridge 20′, having a complementary shape with respect to the shape of the grooves 19a′ and 19b′, and adapted to fit inside the upper groove 19a′, in the closing position of the plug 14 (FIGS. 4a and 4b), and with the lower groove 19b′ in the opening position of the plug 14 (shown in FIG. 2).

The exact configuration of the plug 14 may be inferred, besides from FIGS. 4a and 4b, also from FIG. 1. The plug 14 comprises a portion having the shape of a flanged disc 21′, whose circular flange 18′ abuts on the upper end of the vertical cylindrical wall 9′ of the cartridge or separate container 24, in the closure position of the plug 14 (see FIGS. 4a and 4b); the plug 14 also has vertical elements 22′, in the form of small rods, extending downwards in orthogonal direction to the plane of the flanged disc 21′, and being integral to the latter. The small vertical rods 22′ terminate at their lower ends in a cylindrical ring 23′. The plug 14 can slide, by means of the external surfaces of its portions 22′ and 23′, along the inner side of the vertical cylindrical wall 9′ of the separate container 24.

Moreover, it can be noted that the various vertical rods 22′ of the plug 14 are arranged at equal angles along the periphery of the flanged disc 21′ that forms the upper part of the plug 14. Thus, the small rods 22′ form “windows” of equal dimensions, which are clearly visible in FIG. 1, and which allow the leaking of the seasoning/dressing, etc., from the compartment 3, when the plug 14 is in the opening position (FIG. 1).

According to this solution, the final user can freely choose the seasoning/dressing he/she prefers, by independently purchasing a separate container 24 sealed by the respective plug 14, and containing the desired type of seasoning, dressing or the like. Then, after having turned over the packaging, he/she removes the lower sealing film and inserts the separate container 24 (sealed by the respective plug 14) inside the hole of the container 1, defined by the cylindrical sleeve 11″. Then, the user simply has to push the movable base 13′ inwardly, to the inside of the container 1, and shake the packaging.

Also in this latter solution, the seasoning or the like cannot leak out of the packaging, since the upper sealing film (or the cover) is removed in the last step that is at the end of the operation.

The invention has been described only for illustrative purposes with reference to its preferred embodiments. It goes without saying that various modifications may be conceived by a skilled person, within the same scope of protection.

For example, the number of compartments 3 is not limited to a single compartment, and if desired, more compartments could be provided if for the preparation of the food product it is necessary to mix together more than two components that must maintained in a separate state up to the preparation time.

Now, an alternate embodiment of the present invention will be described.

The embodiments are similar in that the compartment 3 does not form a separate element (in contrast with the cartridge 24 that can be inserted in the container 1), but is connected to the container in a non-removable manner.

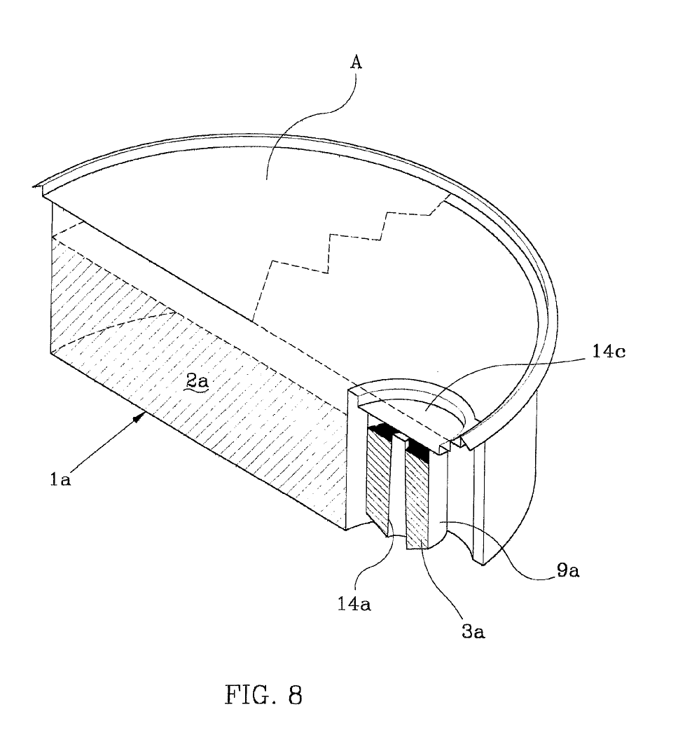

With reference to FIGS. 8 to 10, the packaging of the present invention essentially comprises a single container 1a, which for instance is manufactured using a plastics moulding process. The configuration of the container 1a is such as to give rise to two different compartments, indicated by the numerals 2a and 3a respectively. The first compartment 2a, which has a greater size than the second compartment 3a, contains the ready-made food product (schematically indicated by a hatching in FIG. 8), while the second compartment 3a is used to introduce therein the seasoning, dressing, or the like (which is also schematically shown by a hatching in FIG. 8). Thus, the container 1a forms a small bowl or small basin, of cylindrical external shape, and having inside it a second cylindrical body, which gives rise to the compartment 3a for the dressing, seasoning, or the like.

It should be noted that the container 1a is formed by a thin wall of plastics, that has been adequately shaped in the moulding process, said thin wall being horizontal at the base 8a of the container 1a, and vertical at the cylindrical external wall 5a and at the cylindrical wall 9a of the inner dressing's compartment 3a.

The thin cylindrical wall 9a extends upwards only for a reduced height as compared with the external cylindrical wall 5a, and then it extends downwards so as to form a kind of “well”; the latter gives rise to the compartment 3a that contains the dressing, or seasoning, or bread-crumbs, etc. Centrally, the compartment 3a has a push rod or pointed rod 14a, which internally is hollow, and is formed again by said thin wall of plastic moulding material. Thus, the container 1a is really formed of a single moulded piece of plastics, consisting of a thin wall having the described configuration.

The push rod 14a therefore forms an element having a shape like a frustum of a cone, which is internally hollow (see blind hole 14b), and which is itself formed by said continuous thin wall. Due to the presence of the push rod 14a, the seasoning will occupy inside the compartment 3a, an annular substantially cylindrical region, as may be clearly seen in FIG. 8. The base 13a of the seasoning compartment 3a, having a bulged shape, is located at a level higher than the base 8a of the compartment 2a of the ready-made food product, as indicated by the double arrow F. The reason for this will be explained further below.

Even in this embodiment the seasoning or the like is stored separately from the ready-made food product, since a sealing film 14c is provided at the upper side of the compartment 3a and is applied laterally on the circular step 20a. Moreover, the container 1a is sealed at its upper end by a film A, or by a removable cover made of plastics or the like, that temporarily hermetically closes the container 1a.

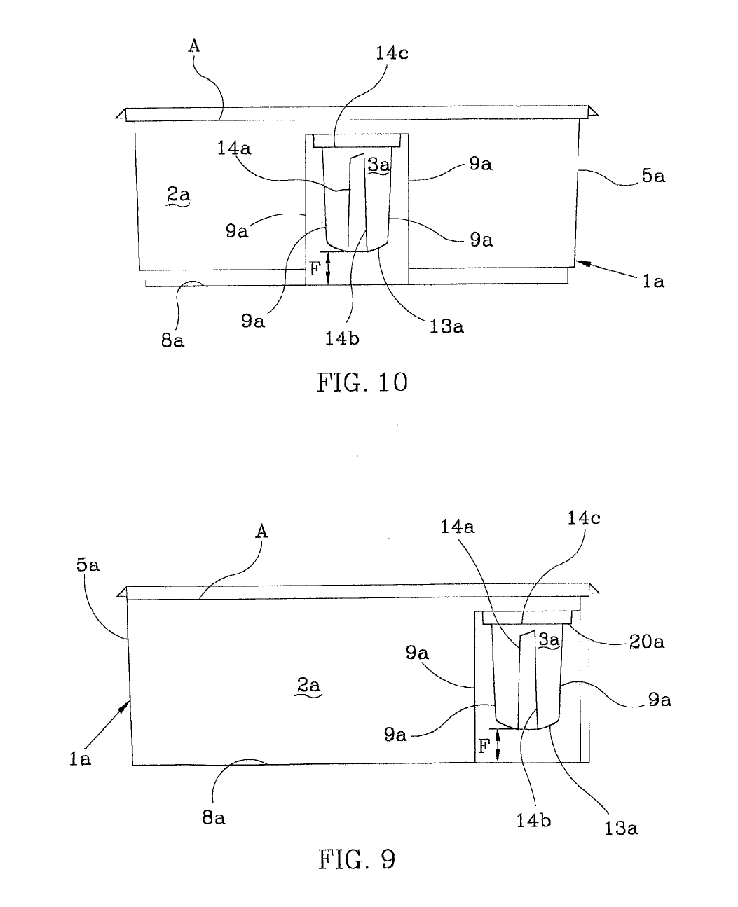

The only difference between FIGS. 8 and 9, on the one hand, and FIG. 10 on the other hand, concerns the position of the compartment 3a for the seasoning; in FIGS. 8 and 9 this compartment 3a is located laterally, while in the version shown in FIG. 10 it is located centrally with respect to the base 8a of the container.

Also in this case the object of the invention can be immediately recognized by the following description of its use.

When the packaging is still sealed, that is before removing the sealing film A from the upper part of the container 1a, the user presses with his/her hand on the bottom 13a of the seasoning's compartment 3a, so as to deform the thin wall of the container at the location of this inner compartment 3a, as shown in FIG. 12. Consequently, the push rod 14a will be lifted and will eventually pierce the closing film 14c of the inner compartment 3a. Without relieving this pressure, the user slowly turns over the packaging, in order to allow the complete downflow of the seasoning or dressing towards the inside of the compartment 2a that contains the food products to be dressed (salad, other vegetables, etc.). Then, the user will simply have to shake the packaging to obtain a perfectly and uniformly dressed salad. At the end of this operation, the external film A (shown clearly in FIG. 8) will be detached. From the above description, it follows that in order to prevent an accidental piercing of the film 14c that seals the compartment 3a for the seasoning/dressing, during packing, transport and selling operations, it is necessary to provide a safety space (denoted by the double arrow F), that has already been mentioned without however clarifying its function.

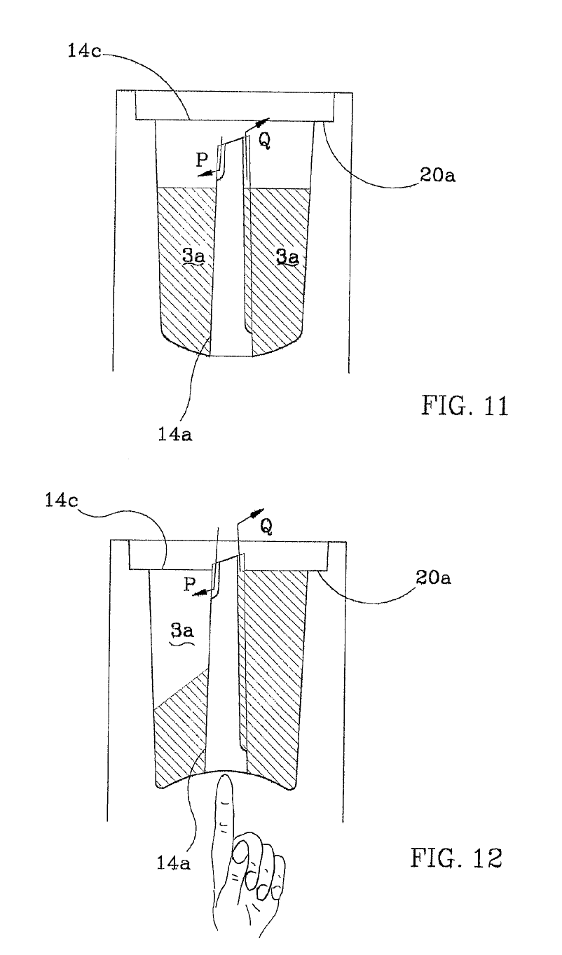

For completeness, and referring again to FIGS. 11 and 12, it should be noted that according to practical tests it results that the downflow of the seasoning/dressing from the compartment 3a is facilitated by the presence of small channels on the lateral surface of the push rod 14a used for piercing the closure film 14c. Thus, the lateral wall of the push rod 14a is recessed (“milled”) on diametrically opposite sides of the push rod, in such a way as to give rise to respective longitudinal channels, of half-cylindrical shape, which extend each as far as the upper end of the push rod 14a; this end is slanted in order to facilitate piercing of the film 14c.

In FIG. 11, the arrow P denotes the path of the air (directed towards the inside of the compartment 3a) after piercing of the film 14c (see FIG. 12), whereas the arrow Q denotes the path of the seasoning/dressing or the like, that flows out of the compartment 3a and reaches the adjacent compartment 2a.

The advantages of the present invention are obvious to the skilled person. In fact, the packaging must be opened only shortly before the food product is eaten, and the system guarantees a perfect dressing.

Although the invention has been extensively described with regard to only some distinct but specific embodiments thereof, a skilled person may easily imagine several constructive modifications without thereby arriving at results out of the scope of protection conferred by this document.

The structure of the packaging may also be more complex. The container could for instance comprise a sealing and removable cover in lieu of the film A, and/or a sliding push rod 14a which slides with respect to the base 13 of the compartment 3a. All these modifications are obviously within the reach of the ordinary skilled person that has taken cognizance of the solutions proposed herein, and for this reason they are to be considered included in the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A food product packaging system for multiple food products, said packaging system comprising:
an upwardly open container having a base, and a defined compartment for a first component of a food product;
an upper closure element of said container; and
at least one additional compartment that is attachable with said container, and which is used for an additional component of said food product to be mixed to said first component;
wherein said additional compartment, which is initially sealed, having a moveable member that may be actuated by the user from outside said container and which has a communication path between said compartment and said additional compartment, thereby allowing to mix the first component of food product located inside said compartment to the additional component of food product coming from said additional compartment, without being forced to open said upper closure member of said container, said moveable member is used to open a sealing means of said additional compartment.

2. The packaging system according to claim 1, wherein said additional compartment is integrally formed to said container.

3. The packaging system according to claim 2, wherein said container is made with a molding process of plastic material and is formed of a thin wall of said plastic material.

4. The packaging system according to claim 1, wherein said moveable member is a push rod comprising a lateral surface that includes channels for the passage of air to the inside of said additional compartment, and channels for the passage of said additional component of said food product towards the outside of said additional compartment.

5. The packaging system according to claim 4, wherein said push rod has a slanted upper end, and wherein said additional compartment has a moveable base which said push rod is attachable thereto.

6. The packaging system according to anyone of the preceding claims 5, wherein said moveable base of said additional compartment is spaced apart from said base of said container.

7. The packaging system according to claim 6, wherein said sealing means of said additional compartment is a film made of a material selected from the group consisting of aluminum, and plastics.

8. The packaging system according to claim 1, wherein said moveable member is a moveable plug, and wherein said additional compartment has a moveable base which said plug is attachable thereto.

9. A food product packaging system for multiple food products, said packaging system comprising:
an upwardly open container having a base, and a defined compartment for a first component of a food product;
an upper closure element of said container; and
a separate sealed container attachable with said container, said separate sealed container having at least one defined additional compartment for an additional component of said food product to be mixed to said first component;
wherein said additional compartment having a moveable push rod that may be actuated by the user from outside said container and which has a communication path between said compartment and said additional compartment, thereby allowing to mix the first component of food product located inside said compartment to the additional component of food product coming from said additional compartment, without being forced to open said upper closure member of said container, said push rod is used to break a sealing means of said additional compartment.
wherein said push rod comprising a lateral surface that includes channels for the passage of air to the inside of said additional compartment, and channels for the passage of said additional component of said food product towards the outside of said additional compartment.

10. The packaging system according to claim 9, wherein said push rod has a slanted upper end, and wherein said additional compartment has a moveable base which said push rod is attachable thereto.

11. The packaging system according to anyone of the preceding claims 10, wherein said moveable base of said additional compartment is spaced apart form said base of said container.

12. The packaging system according to claim 11, wherein said sealing means of said additional compartment is a film made of a material selected from the group consisting of aluminum, and plastics.

13. A food product packaging system for multiple components of a food product, said packaging system comprising:
a container having a base, a compartment for a first component of said food product in which said components are to be mixed together, and a defined coupling hole;
an upper closure element and a lower closure element of said container;
a sealed separate container attachable in said coupling hole of said container, said separate container having a moveable plug, and a moveable base hingedly connect to a wall of said separate compartment, said moveable plug being actuated by a user and has a communication path between said compartment of said container; and
an additional compartment defined by said separate container for an additional component of said food product, said additional compartment being adapted to slidably receive said moveable plug therein;
wherein said moveable base of said separate container is movable between a first position, and a second position, and during the displacement to said second position said moveable base acts on said moveable plug that slides along said walls of said separate container; said moveable plug having lateral apertures which give rise to said communication path between said compartment and said additional compartment, in said second position of said movable base.

14. The packaging system according to claim 13, wherein said container is made with a molding process of plastic material and is formed of a thin wall of said plastic material.

15. The packaging system according to claim 13, wherein said upper and lower closure elements are formed by a film, and said lower film closes said coupling hole.

16. The packaging system according to claim 13, wherein said movable plug is connected to said movable base through an axial stem.

17. The packaging system according to claim 16, wherein said separate container further comprising at least two circular ridges positioned on said wall and corresponding to said first and second positions of said moveable base, and wherein said moveable plug further comprising at least one circular groove corresponding to said circular ridges and adapted to seal said moveable plug and said wall of said separate container.

18. The packaging system according to claim 17, wherein said separate container is retained in a coaxial position inside said coupling hole of said container by the friction force and the radial pressure which is exerted by walls on a sleeve which surrounds said hole and is integrally formed with said base of said container.

19. The packaging system according to claim 18, wherein said base of said container presents a recess in order to receive pieces of cutlery, and is provided with a lower closure film.

20. The packaging system according to claim 18, wherein the lower extension of said walls of said separate container comprises a flange acting as a stop to prevent the stroke of said separate container during its insertion inside said container, and wherein said container and said separate container have a seal obtained by the coupling between an annular ridge on said wall of said separate container and an circular groove on said wall of said sleeve of said container.
